(19) United States
(12) Patent Application Publication
(10) Pub. No.: US 2023/0330457 A1
(43) Pub. Date: Oct. 19, 2023

(54) Fire Safety Device for a Tree

(71) Applicant: Ray Rivera, Sicklerville, NJ (US)

(72) Inventor: Ray Rivera, Sicklerville, NJ (US)

(21) Appl. No.: 17/847,411

(22) Filed: Jun. 23, 2023

Related U.S. Application Data
(60) Provisional application No. 63/330,939, filed on Apr. 14, 2022.

(51) Int. Cl. A62C 3/00; A62C 37/40; G08B 17/10

(52) U.S. Cl. CPC A62C 3/00; A62C 37/40; G08B 17/10

(57) ABSTRACT

The present invention relates to a novel fire safety device. The device is designed to allow users to maintain household safety while having a fully lit and decorated Christmas tree for the holidays. The device comprises a faux wrapped present connected to a flexible tube that is attached around the trunk of a Christmas tree. The flexible tube has several nozzle heads connected to wiring equipped with multiple smoke detection units. Once smoke or fire is detected via the units, the device automatically releases the fire retardant onto the Christmas tree. Further, the device improves household safety during the holiday season.

### CROSS-REFERENCE TO RELATED APPLICATION

The present application claims priority to, and the benefit of, U.S. Provisional Application No. 63/330,939, which was filed on Apr. 14, 2022 and is incorporated herein by reference in its entirety.

### FIELD OF THE INVENTION

The present invention relates generally to the field of fire safety devices for Christmas trees. More specifically, the present invention relates to an improved fire safety device that provides users with a fire extinguishing system capable of sensing when a Christmas tree starts to burn, spraying fire-retardant foam onto the tree to put out the fire. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in fire safety devices for Christmas trees. A Christmas tree, though very festive, is a great fire hazard for the home. There has been a need to provide fire detection devices in and around the tree to alert the residents of a potential fire should something go awry. Furthermore, should a fire start on a Christmas tree, there may be no one around to extinguish the fire, so a fire prevention means is also a desirable aspect to incorporate into a Christmas tree.

Furthermore, special fire safety precautions need to be taken when keeping a live Christmas tree in the house. A burning tree can rapidly fill a room with fire and deadly gas. When choosing a tree, care should be taken to ensure that the tree is fresh, and that the needles are green and hard to pull back from the branches. The needles should not break if the tree has been freshly cut, and the trunk should be sticky to the touch. Old trees can be identified by bouncing the tree trunk on the ground. If many needles fall off, the tree has been cut too long, has probably dried out, and is a fire hazard and should be avoided.

After choosing a fresh tree, careful consideration must be given to where it is placed in the home. For instance, a tree should not be positioned close to a heat source, such as a fireplace or a heat vent. The heat will dry out the tree, causing it to be more easily ignited by heat, flame, or sparks. Further, smokers should not drop or flick cigarette ashes near a tree, and a live tree should not be put up too early or left up for longer than two weeks. The tree should be mounted to a tree stand, which needs to be filled with water at all times.

If a tree is to be trimmed with holiday lights, the lights should be inspected for frayed wires, bare spots, gaps in insulation, broken or cracked sockets, and excessive kinking or wear before putting them on the tree. Only lighting listed by an approved testing laboratory should be used, and care must be taken not to link more than three light strands, unless the directions with the lights indicate it is safe to do so. It is also important to connect strings of lights to an extension cord before plugging the cord into an outlet, and all wires should be periodically inspected to make sure they are not warm to the touch.

Regardless of how much care one takes in choosing, installing, and trimming a tree, a live Christmas tree located within the home constitutes a fire risk. Although many homeowners are careful to have fire extinguishers on hand in the event the tree catches fire, a burning tree normally consumes a room with fire and deadly gas so quickly that homeowners are left with no other choice than to find their loved ones and evacuate the premises only to see their homes consumed by fire. Although the art is replete with various forms of fire extinguishers, relatively little effort has been devoted toward fire extinguishers that are specifically adapted to be used in conjunction with a Christmas tree.

It is known that Christmas trees and especially those comprised of a live tree present a fire hazard. As such, devices for detecting a fire condition have been introduced in the prior art. However, these devices, simply because of their limited size, are limited to being strictly alarms, such as a smoke detector, or hold and discharge relatively small quantities of fire extinguishing material, which limits their effectiveness. Furthermore, those with a larger exposed tank are aesthetically undesirable.

Accordingly, a need remains for a Christmas tree fire extinguishing device to overcome the above-noted shortcomings. The present invention satisfies such a need by providing a device that is convenient and easy to use, is durable in design, is versatile in its application, and effectively reduces the likelihood of fire damage to an existing Christmas tree and surrounding objects.

Therefore, there exists a long-felt need in the art for a fire safety device that provides users with a fire extinguishing system capable of sensing when a Christmas tree starts to burn. There is also a long-felt need in the art for a fire safety device that sounds a loud, audible alert upon activation to alert home inhabitants to evacuate to keep them safe. Further, there is a long-felt need in the art for a fire safety device that features a faux present at the base that hides the fire foam dispensing system, maintaining the ideal Christmas and holiday aesthetic. Moreover, there is a long-felt need in the art for a device that sprays fire-retardant foam onto the tree to put out the fire. Further, there is a long-felt need in the art for a fire safety device that utilizes several nozzle heads and sensors that work in conjunction to dispense the fire foam from the faux present. Finally, there is a long-felt need in the art for a fire safety device that improves household safety during the holiday season.

The subject matter disclosed and claimed herein, in one embodiment thereof, comprises a fire safety device. The device is designed to allow users to maintain household safety while having a fully lit and decorated Christmas tree for the holidays. The device comprises a faux wrapped present, connected to a flexible tube that is attached around the trunk of a Christmas tree. The flexible tube has several nozzle heads connected to wiring equipped with multiple smoke detection units. Once smoke or fire is detected via the units, the device automatically releases the fire retardant onto the Christmas tree. Further, the device improves household safety during the holiday season.

In this manner, the fire safety device of the present invention accomplishes all of the foregoing objectives and provides users with a fire extinguishing system capable of sensing when a Christmas tree starts to burn, spraying fire-retardant foam onto the tree to put out the fire. The device allows a user to maintain household safety while having a fully lit and decorated Christmas tree for the holidays. The device improves household safety while maintaining the ideal Christmas aesthetic.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fire safety device. The device is designed to allow users to maintain household safety while having a fully lit and decorated Christmas tree for the holidays. The device comprises a faux wrapped present connected to a flexible tube that is attached around the trunk of a Christmas tree. The flexible tube has several nozzle heads connected to wiring equipped with multiple smoke detection units. Once smoke or fire is detected via the units, the device automatically releases the fire-retardant foam onto the Christmas tree. Further, the device improves household safety during the holiday season.

In one embodiment, a fire safety device for reducing a likelihood of fire damage to an existing Christmas tree and surrounding objects preferably includes an air-pressurized reservoir which may be adapted to be removably positioned at a base of the existing Christmas tree. Such an air-pressurized reservoir may be suitably sized and shaped for simulating a gift-wrapped present. Of course, the air-pressurized reservoir may also be conveniently sized and shaped for simulating a number of different objects. In this manner, an unexpected benefit is provided to users who would otherwise not desire to place a bulky, bright-red fire extinguisher or other fire-retardant devices among an often elaborate and expensive holiday arrangement.

In this embodiment, the reservoir may contain a fire-retardant agent. The fire-retardant material is any suitable dry or wet fire-retardant material, and the reservoir is rechargeable, if desired. Such a fire-retardant agent may be maintained at an initial compressed state by the air-pressurized reservoir. The air-pressurized reservoir may include a manual shut off valve which is important for activating and deactivating the device. The fire safety device may also include a mechanism for automatically discharging the fire-retardant agent along a diverging target path when an unsafe triggering event is detected. Such a target path may begin at an apex of the existing Christmas tree and terminate at the base of the existing Christmas tree.

Dispensing the fire-retardant at the apex allows the automatic fire-retardant agent discharging mechanism to cover a major surface area of the existing Christmas tree as well as the surrounding area where fire is most likely to reach. In this manner, the user avoids the risk of a quick-spreading fire growing beyond the tree and consuming surrounding objects/structures. The unsafe triggering event may be detected when a real-time ambient temperature level surrounding the existing Christmas tree elevates beyond a predefined maximum threshold temperature level.

Furthermore, a conduit assembly couples a reservoir to a dispensing element. In the immediate embodiment, a pair of cooperating conduits characterize the conduit assembly, although less or more can be used. Dispensing element consists of an elongate, foraminous tube having a proximal end coupled to a conduit assembly and a distal end attached to a detection assembly. Any suitable means of attachment can be used to couple proximal end to conduit assembly and distal end to detection assembly, such as welding, threaded attachment, adhesive attachment, etc. The tube or conduit may be fashioned from any suitable flexible or non-flexible fire-resistant material or combination of materials, and is formed with holes or openings, as well as a plurality of nozzle heads, which extend therethrough and are dispersed in one or more regular and/or irregular patterns extending substantially from proximal end to distal end. If desired, the dispensing element can be coupled directly to the source without the provision of conduit assembly.

In one embodiment, the dispensing element may further be adapted to be camouflaged and removably attached to the existing Christmas tree. Specifically, the dispensing element may have a natural color scheme, including green or brown colors, to blend into the tree itself. In this manner, the user may easily position the flexible tube at the apex and easily bend and wrap the flexible tube through the branches of the tree, thereafter, connecting the tube to the reservoir at the base.

Further, the dispensing element may include a valve. Such a valve preferably includes an axial bore formed therein and may be directly connected, without the use of intervening elements, to the upper end of the flexible tube. The axial bore may also be in fluid communication with the upper end of the tube.

The dispensing element may include a fire-retardant agent which is maintained at a pressurized state within the tube and the axial bore during non-operating conditions. The fire-retardant agent may be upwardly urged through the tube and the axial bore when the triggering-event is detected. In operation, when an elevated air-temperature from heat or fire alerts the device, the fire-retardant is ejected from tube through the valve into the tree and directed downward along the target path to cover the tree and surrounding area.

In one embodiment, the detection assembly consists of a housing, which is constructed of any suitable flexible or non-flexible fire-resistant material or combination of materials and supports sensors and contains a power source, such as one or more conventional non-rechargeable and/or rechargeable batteries. Conventional electrical interconnections and circuitry (not shown) are used to connect the power source to sensors and valve to facilitate signal communication between the sensors and valve. Sensors are combustion sensors, namely, conventional heat and/or smoke detection sensors, that in response to sensing heat and/or smoke (which are a byproduct of combustion) generate and send a signal to the valve causing it to move from its normal closed position to an open position. When the valve moves into its open position, fire-retardant material passes forcibly from reservoir to the dispensing element through the conduit assembly and is dispersed forcibly from the dispensing element through its foramina so as to be applied to the fire. Sensors are disposed at spaced intervals and any desired number can be used, whether two or more. Only one sensor can be used, if desired. Sensors can be attached at other locations, such as to the dispensing element or reservoir.

In accordance with the principle of the invention, housing can be decorative in nature to blend in with the Christmas tree and/or can resemble a star, an ornament, an angel, a decorative ball, or any other desired ornamentation form.

In a typical installation, the flexible tube is secured to the branches and or trunk of a Christmas tree, such as with tying or the like, so as to dispose the housing at the top of the Christmas tree. Should the Christmas tree catch fire, such as from defective wiring from Christmas lights, the fire will generate heat and smoke. In response to sensing heat and/or smoke from the fire, sensors are responsive and generate signals to the valve causing it to move from its normal closed position to an open position. When the valve moves into its open position as previously explained, the fire-retardant material maintained by the reservoir passes forcibly from the reservoir to the dispensing element through conduit assembly and is dispersed forcibly from the dispensing element through its foramina so as to be applied to the fire to extinguish/suppress it. A plurality of sensors are used for redundancy in case certain sensors fail for some reason. Nevertheless, and as previously explained, only one sensor can be used with the invention.

Although the power source of the invention consists of one or more conventional batteries, whether rechargeable, maintained and supported by housing, the power source can be supported elsewhere, such as at the reservoir. The reservoir, if desired, can be provided with a conventional power cord for engaging a wall outlet to provide the sensors and valve with electrical power. Also, in an effort to inhibit the reservoir from catching fire, it is preferred that the various elements of the reservoir be fashioned of fire-resistant materials. It is to be understood that although the invention is particularly useful in a Christmas tree application, it is also useful in other applications. In this regard, the housing and/or the reservoir can be of any desired design, whether secular or non-secular.

In a particular embodiment, sensors are heat sensors and the invention is configured with a temperature sensor set at a predetermined threshold temperature, in which the sensors will only activate to open the valve when the sensed temperature reaches the threshold temperature. In another embodiment, sensors are configured to activate and send signals to the valve to open only in response to sensing both smoke and heat. In still another embodiment, the invention is configured with an alarm, which is activated by sensors in response to sensing heat and/or smoke, for the purposes of alerting occupants of the household to the threat of fire. The alarm can be an audible alarm for issuing an audible stimulus, a visual alarm for issuing a visual stimulus, or a combination thereof. In yet another embodiment, the invention is configured with a “kill” or “override” switch which when activated, deactivates the device.

In one embodiment, electrical wiring connects the smoke detector and the heat detector to the rest of the invention. However, wireless capabilities can be introduced to the smoke detector and the heat detector, such that a radio signal is transmitted to the rest of the invention. The only additional requirement to make the wireless embodiment feasible is the introduction of a battery supply into the smoke detector and the heat detector.

Further, the electrical wiring runs from the location of the Christmas tree trunk to a control box, which is located on the floor immediately adjacent to the Christmas tree and within the reservoir. It shall be further asserted that under the wireless embodiment mentioned above, the control box should still be required to be located on the floor immediately adjacent to the Christmas tree.

The control box comprises an on/off switch that is securely mounted to a side of the control box. Electrical wiring connects the on/off switch to a central processing unit (hereinafter CPU), which is located inside of the control box. A power cord connects to the CPU and provides continuous AC power to the CPU. Should the power source provided through the power cord run out, a backup battery supply (not shown) would provide a continuous supply of electrical power to the CPU such that the invention will not unexpectedly turn off.

Electrical wiring runs from the CPU to a pump that when energized, will pump fire-retardant material (not shown) from the fluid reservoir. The fluid reservoir is located in the interior of the control box. The fluid reservoir is connected to the pump by a hose (not shown), or the pump is permanently affixed to a predetermined exterior position on the fluid reservoir so as to eliminate the need for a connecting hose (not shown).

When a smoke detector senses smoke, the smoke detector sends a signal either via the electrical wire or via a wireless means (not shown) to the CPU. The CPU then processes said signal, and transfers electrical power to the pump. Located on the pump is a high-pressure outlet (not shown), which is connected to the dispensing element. The dispensing element has a length that enables it to run up the height of the Christmas tree. The dispensing element also has a plurality of holes that are cut out of the fire extinguishing tube so that when fire-retardant fluid (not shown) travels up the fire extinguishing tube, a stream of fire-retardant fluid is ejected from the tube. The result is a plurality of streams of fire-retardant fluid (not shown) that encompasses every possible area that a fire might burn from the Christmas tree.

When either the smoke detector senses smoke or the heat detector senses heat, the respective detector will send a signal to the CPU, which will in turn transmit an audible signal to a speaker. The speaker will generate noise that is comparable to any smoke detector or alarm. In the event of a fire in which the fire extinguishing means provided is not effective, an additional feature of the invention is required. The additional feature of the invention is to continuously run the speaker system for an extended period regardless of power or intense heat generated by the fire which may destroy the smoke detector. This added feature provides the end user with peace of mind in knowing that the alarm will continue to sound long after various components of the invention are destroyed or from loss of power.

The additional feature of the invention is to provide a remote alarm system that consists of a transmitter that is electrically wired to the CPU. The transmitter sends a radio signal out from the invention to a remote receiver, which will activate an alarm system that is broadcasted over a remote speaker. The remote receiver, alarm system, and remote speaker are contained within a housing (not shown) that is separate from the rest of the invention and can be located anywhere within a predetermined range of the transmitter. The benefit of the remote alarm system is to provide a more expansive alarm system that can be heard of a greater distance, which may be required for a large home, a home with a guest house, or similar residential accommodations.

In one embodiment, the fire safety device further may include a mechanism for automatically emitting an alarm signal when the automatic fire-retardant agent is discharged. The combined elements of the automatic alarm signal emitting mechanism and the automatic fire-retardant agent, provide an unexpected benefit wherein the device not only prevents fires from spreading and extinguishes fires but also warns users of the dangerous conditions.

Upon activation, the automatic alarm signal emitting mechanism may be independently and simultaneously operable from the reservoir. This operates such that the alarm signal is continuously emitted after the fire-retardant agent is depleted from the air-pressurized reservoir while the real-time ambient temperature level is above the maximum threshold temperature level. This may notify the user from a distance that a dangerous condition may still be present even after the device has discharged all the fire-retardant agent.

The automatic alarm signal emitting mechanism may further include a power source. Such a power source may be a standard alkaline battery coupled to the automatic alarm signal, thereby allowing the alarm signal to be activated even if a power outage were present. Also, a temperature-detecting controller may be electrically coupled to the power source and arranged in such a manner to detect the real-time ambient temperature level surrounding the existing Christmas tree.

In yet another embodiment, a method of maintaining household safety while having a fully lit and decorated Christmas tree for the holidays is described. The method includes the steps of providing a fire safety device comprising a faux wrapped present connected to a flexible tube that is attached around the trunk of a Christmas tree, the device releases fire retardant onto the tree when on fire. The method also comprises positioning the flexible tube around a trunk of a Christmas tree and connecting the tube to the fire foam container inside of a faux present. Further, the method comprises detecting a fire via sensors within the Christmas tree. The method comprises sounding an audible alert to alert home inhabitants to evacuate. Finally, automatically triggering the fire retardant to put out the fire.

Should a Christmas tree catch fire, such as from defective wiring from Christmas lights, the fire will generate heat and smoke. In response to sensing heat and/or smoke from the fire, sensors are responsive and generate signals to the valve causing it to move from its normal closed position to an open position. When the valve moves into its open position, the fire-retardant material maintained by the reservoir passes forcibly from the reservoir to the elongate, foraminous tube through the conduit assembly and is dispersed forcibly from the foramina formed in the elongate, foraminous tube along its entire length from the proximal end at the lower end of the branched structure to the distal end at the upper end of the branched structure, thereby applying the fire retardant outwardly from the elongate, foraminous tube onto the trunk and into and through the branched structure.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a perspective view of one potential embodiment of the fire safety device of the present invention in accordance with the disclosed architecture;

FIG. 1B illustrates a cross-sectional view of one potential embodiment of the fire safety device of the present invention in accordance with the disclosed architecture;

FIG. 2 illustrates a perspective view of one embodiment of the fire safety device of the present invention disclosing a faux present in accordance with the disclosed architecture;

FIG. 3 illustrates a perspective view of one embodiment of the fire safety device of the present invention disclosing the fire foam container inside the faux present in accordance with the disclosed architecture;

FIG. 4 illustrates a perspective view of one embodiment of the fire safety device of the present invention wherein the tree is on fire in accordance with the disclosed architecture;

FIG. 5 illustrates a perspective view of one embodiment of the fire safety device of the present invention disclosing the device in use in accordance with the disclosed architecture; and

FIG. 6 illustrates a flowchart showing the method of maintaining household safety while having a fully lit and decorated Christmas tree for the holidays in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a fire safety device that provides users with a fire extinguishing system capable of sensing when a Christmas tree starts to burn. There is also a long-felt need in the art for a fire safety device that sounds a loud, audible alert upon activation to alert home inhabitants to evacuate to keep them safe. Further, there is a long-felt need in the art for a fire safety device that features a faux present at the base that hides the fire foam dispensing system, maintaining the ideal Christmas and holiday aesthetic. Moreover, there is a long-felt need in the art for a device that sprays fire-retardant foam onto the tree to put out the fire. Further, there is a long-felt need in the art for a fire safety device that utilizes several nozzle heads and sensors that work in conjunction to dispense the fire foam from the faux present. Finally, there is a long-felt need in the art for a fire safety device that improves household safety during the holiday season.

The present invention, in one exemplary embodiment, is a novel fire safety device. The device is designed to allow users to maintain household safety while having a fully lit and decorated Christmas tree for the holidays. The device comprises a faux wrapped present connected to a flexible tube that is attached around the trunk of a Christmas tree. The flexible tube has several nozzle heads connected to wiring equipped with multiple smoke detection units. Once smoke or fire is detected via the units, the device automatically releases the fire retardant onto the Christmas tree. The present invention also includes a novel method of maintaining household safety while having a fully lit and decorated Christmas tree for the holidays. The method includes the steps of providing a fire safety device comprising a faux wrapped present connected to a flexible tube that is attached around the trunk of a Christmas tree, the device releases fire retardant onto the tree when on fire. The method also comprises positioning the flexible tube around a trunk of a Christmas tree and connecting the tube to the fire foam container inside of a faux present. Further, the method comprises detecting a fire via sensors within the Christmas tree. The method comprises sounding an audible alert to alert home inhabitants to evacuate. Finally, automatically triggering the fire retardant to put out the fire.

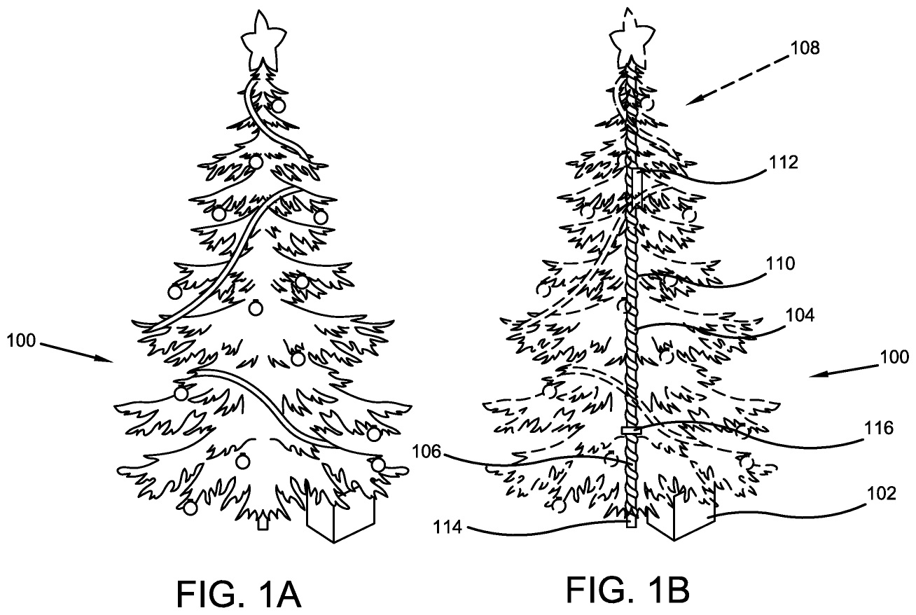

Referring initially to the drawings, FIGS. 1A-B illustrate a perspective view of one embodiment of the fire safety device 100 of the present invention. In the present embodiment, the fire safety device 100 is a fire safety device that improves household safety during the holiday season. The device 100 is especially designed to allow any suitable user as is known in the art, to maintain safety while having a fully lit and decorated Christmas tree for the holidays. More specifically, the device 100 comprises a faux wrapped present or reservoir 102 connected to a flexible tube or dispensing element 104 that is attached around the trunk 106 of a Christmas tree 108. The flexible tube 104 has several nozzle heads 110 connected to wiring equipped with multiple smoke detection units or detection assembly 112. Once smoke or fire is detected via the units 112, the device 100 automatically releases the fire retardant onto the Christmas tree 108.

As seen in FIGS. 1A-B, a vertical sectional view of a Christmas tree 108 includes a trunk 106 that extends upwardly from a base 114. The trunk 106 has a lower extremity secured at tree stand or base 114, and an opposed upper extremity. Secondary branches are supported on trunk 106 and extend along substantially the entire length of trunk 106 from adjacent to lower extremity to upper extremity, whereby a portion of the length of trunk 106 extending upwardly from lower extremity is generally free of branches as illustrated. The branches form a branched structure of the tree 108. Branched structure has a lower end adjacent to lower extremity of trunk 106, and an upper end at upper extremity of trunk 106. Branched structure is generally cone-shaped having a broad base constituting lower end, and which gradually tapers upwardly therefrom to a relative pointed top at upper end. The device 100 is connected to a flexible tube or dispensing element 104 that is attached around the trunk 106 of the Christmas tree 108. The flexible tube 104 has several nozzle heads 110 connected to wiring equipped with multiple smoke detection units or detection assembly 112.

In one embodiment, the dispensing element 104 may further be adapted to be camouflaged and removably attached to the existing Christmas tree 108. Specifically, the dispensing element 104 may have a natural color scheme including green or brown colors to blend into the tree 108 itself. In this manner, the user may easily position the flexible tube 104 at the apex and easily bend and wrap the flexible tube 104 through the branches of the tree 108, thereafter connecting the tube 104 to the reservoir 102 at the base 114.

Further, the dispensing element 104 may include a valve 116. Such a valve 116 preferably includes an axial bore (not shown) formed therein and may be directly connected, without the use of intervening elements, to the upper end of the flexible tube 104. The axial bore may also be in fluid communication with the upper end of the tube 104.

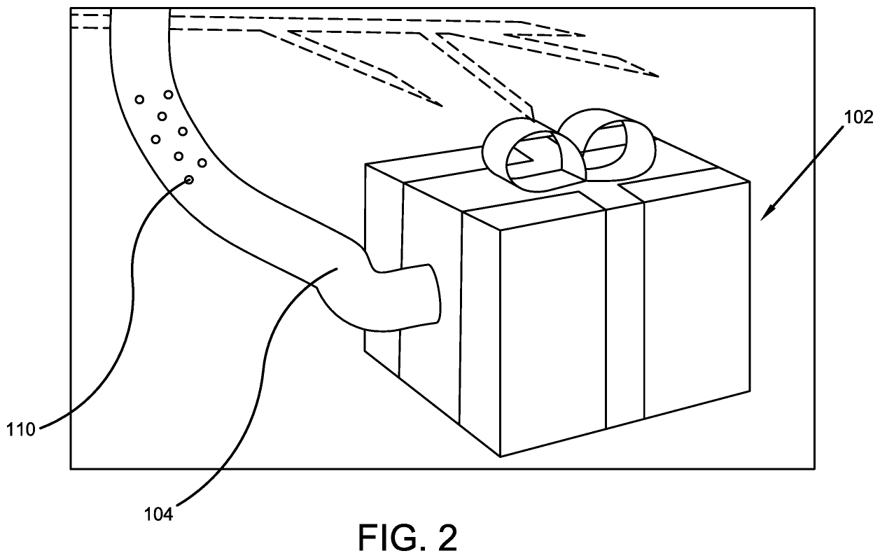

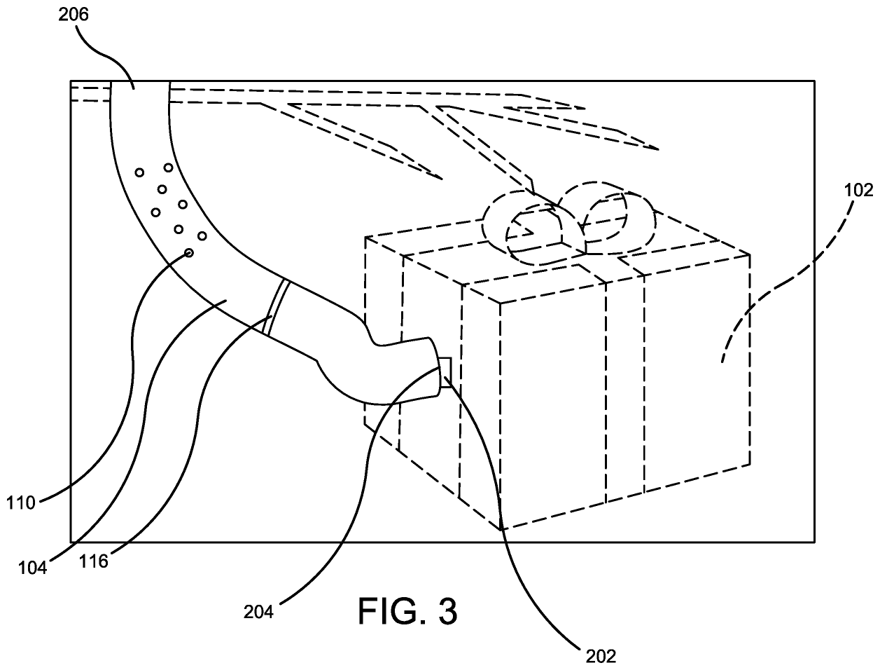

As shown in FIGS. 2-3, the fire safety device 100 for reducing a likelihood of fire damage to an existing Christmas tree and surrounding objects, preferably includes an air-pressurized reservoir 102 which may be adapted to be removably positioned at a base 114 of the existing Christmas tree 108. Such an air-pressurized reservoir 102 may be suitably sized and shaped for simulating a gift-wrapped present. Of course, the air-pressurized reservoir 102 may also be conveniently sized and shaped for simulating a number of different objects. In this manner, an unexpected benefit is provided to users who would otherwise not desire to place a bulky, bright-red fire extinguisher or other fire-retardant devices among an often elaborate and expensive holiday arrangement.

In this embodiment, the reservoir 102 may contain a fire-retardant agent. The fire-retardant material is any suitable dry or wet fire-retardant material, and the reservoir 102 is rechargeable, if desired. Such a fire-retardant agent may be maintained at an initial compressed state by the air-pressurized reservoir 102. The air-pressurized reservoir 102 may include a manual shut off valve 200 which is important for activating and deactivating the device 100. The fire safety device 100 may also include a mechanism for automatically discharging the fire-retardant agent along a diverging target path when an unsafe triggering event is detected. Such a target path may begin at an apex of the existing Christmas tree 108 and terminate at the base 114 of the existing Christmas tree 108.

Dispensing the fire-retardant at the apex allows the automatic fire-retardant agent discharging mechanism to cover a major surface area of the existing Christmas tree 108 as well as the surrounding area where fire is most likely to reach. In this manner, the user avoids the risk of a quick-spreading fire growing beyond the tree 108 and consuming surrounding objects/structures. The unsafe triggering event may be detected when a real-time ambient temperature level surrounding the existing Christmas tree 108 elevates beyond a predefined maximum threshold temperature level.

Furthermore, a conduit assembly 202 couples the reservoir 102 to the dispensing element 104. In the immediate embodiment, a pair of cooperating conduits characterizes conduit assembly 202, although less or more can be used. Dispensing element 104 consists of an elongate, foraminous tube having a proximal end 204 coupled to conduit assembly 202 and a distal end 206 attached to a detection assembly 112. Any suitable means of attachment can be used to couple proximal end 204 to conduit assembly 202 and distal end 206 to detection assembly 112, such as welding, threaded attachment, adhesive attachment, etc. Tube 104 is fashioned from any suitable flexible or non-flexible fire-resistant material or combination of materials, and is formed with holes or openings, as well as a plurality of nozzle heads 110, which extend therethrough and are dispersed in one or more regular and/or irregular patterns extending substantially from proximal end 204 to distal end 206. If desired, dispensing element 104 can be coupled directly to source without the provision of conduit assembly 202.

The dispensing element 104 may include a fire-retardant agent which is maintained at a pressurized state within the tube 104 and the axial bore during non-operating conditions. The fire-retardant agent may be upwardly urged through the tube 104 and the axial bore when the triggering-event is detected. In operation, when an elevated air-temperature from heat or fire alerts the device, fire-retardant is ejected from tube 104 through the valve 116 into the tree 108 and directed downward along the target path to cover the tree 108 and surrounding area.

In one embodiment, detection assembly 112 consists of a housing 300, which is constructed of any suitable flexible or non-flexible fire-resistant material or combination of materials and supports sensors 302 and contains a power source 304, such as one or more conventional non-rechargeable and/or rechargeable batteries. Conventional electrical interconnections and circuitry (not shown) are used to connect the power source 304 to the sensors 302 and valve 116 to facilitate signal communication between sensors 302 and valve 116. Sensors 302 are combustion sensors, namely, conventional heat and/or smoke detection sensors, that in response to sensing heat and/or smoke (which are each a byproduct of combustion) generate and send a signal to valve 116 causing it to move from its normal closed position to an open position. When valve 116 moves into its open position, fire-retardant material passes forcibly from reservoir 102 to dispensing element 104 through conduit assembly 202 and is dispersed forcibly from dispensing element 104 through its foramina so as to be applied to the fire. Sensors 302 are disposed at spaced intervals and any desired number can be used, whether two or more. Only one sensor 302 can be used, if desired. Sensors 302 can be attached at other locations, such as to the dispensing element 104 or reservoir 102.

In accordance with the principle of the invention, housing 300 can be decorative in nature, to blend in with the Christmas tree 108 and/or can resemble a star, an ornament, an angel, a decorative ball, or any other desired ornamentation form.

In a typical installation, the flexible tube 104 is secured to the branches and or trunk 106 of a Christmas tree 108, such as with tying or the like, so as to dispose housing 300 at the top of the Christmas tree 108. Should Christmas tree 108 catch fire, such as from defective wiring from Christmas lights, the fire will generate heat and smoke. In response to sensing heat and/or smoke from the fire, sensors 302 are responsive and generate signals to valve 116 causing it to move from its normal closed position to an open position. When valve 116 moves into its open position as previously explained, the fire-retardant material maintained by reservoir 102 passes forcibly from reservoir 102 to dispensing element 104 through conduit assembly 202 and is dispersed forcibly from dispensing element 104 through its foramina so as to be applied to the fire to extinguish/suppress it. A plurality of sensors 302 are used for redundancy in case certain sensors fail for some reason. Nevertheless, and as previously explained, only one sensor 302 can be used with the invention.

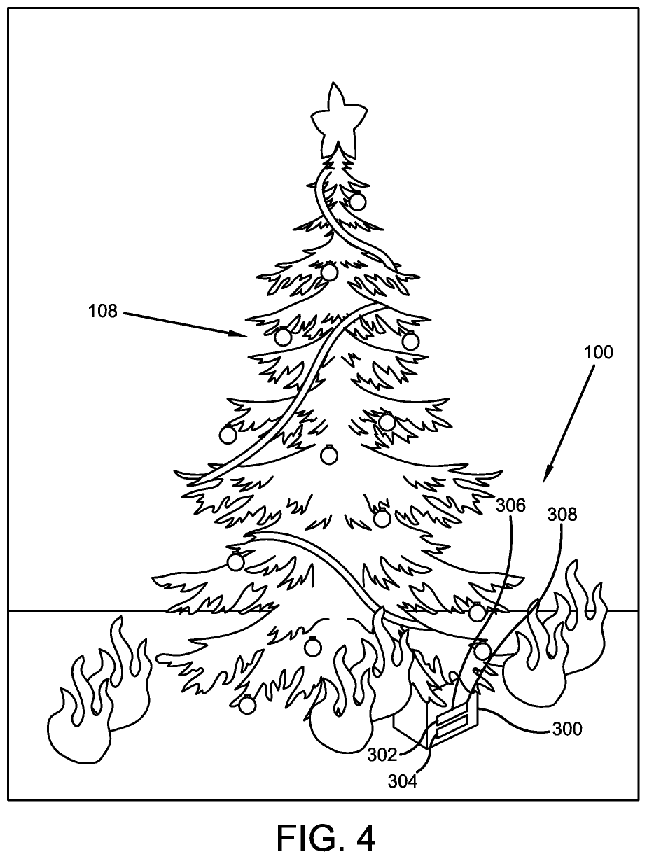

As shown in FIG. 4, although the power source 304 of the invention 100 consists of one or more conventional or rechargeable batteries, whether rechargeable, maintained and supported by housing 300, the power source 304 can be supported elsewhere, such as at reservoir 102. Reservoir 102, if desired, can be provided with a conventional power cord for engaging a wall outlet to provide sensors 302 and valve 116 with electrical power. Also, in an effort to inhibit reservoir 102 from catching fire, it is preferred that the various elements of the reservoir 102 be fashioned of fire-resistant materials. It is to be understood that although the invention is particularly useful in a Christmas tree application, it is also useful in other applications. In this regard, housing 300 and/or reservoir 102 can be of any desired design, whether secular or non-secular.

In a particular embodiment, sensors 302 are heat sensors 306 and the invention is configured with a temperature sensor 308 set at a predetermined threshold temperature, in which the sensors 302 will only activate to open valve 116 when the sensed temperature reaches the threshold temperature. In another embodiment, sensors 302 are configured to activate and send signals to valve 116 to open it only in response to sensing both smoke and heat. In still another embodiment, the invention is configured with an alarm 400, which is activated by sensors 302 in response to sensing heat and/or smoke, for the purposes of alerting occupants of the household to the threat of fire. The alarm 400 can be an audible alarm for issuing an audible stimulus, a visual alarm for issuing a visual stimulus, or a combination thereof. In yet another embodiment, the invention is configured with a “kill” or “override” switch 402 which when activated, deactivates the device 100.

In one embodiment, electrical wiring connects the smoke detector and the heat detector to the rest of the invention. However, wireless capabilities can be introduced to the smoke detector and the heat detector, such that a radio signal is transmitted to the rest of the invention. The only additional requirement to make the wireless embodiment feasible, is the introduction of a battery supply into the smoke detector and the heat detector.

Further, the electrical wiring runs from the location of the Christmas tree trunk to a control box 404, which is located on the floor immediately adjacent to the Christmas tree and within the reservoir 102. It shall be further asserted that under the wireless embodiment mentioned above, the control box 404 should still be required to be located on the floor immediately adjacent to the Christmas tree 108.

The control box 404 comprises an on/off switch 406 that is securely mounted to a side of the control box 404. Electrical wiring connects the on/off switch 406 to a central processing unit (hereinafter CPU) 408, which is located inside of the control box 404. A power cord 410 connects to the CPU 408 and provides continuous AC power to the CPU 408. Should the power source provided through the power cord 410 run out, a backup battery supply (not shown) would provide a continuous supply of electrical power to the CPU 408 such that the invention will not unexpectedly turn off.

Electrical wiring runs from the CPU 408 to a pump 412 that when energized, will pump fire-retardant material (not shown) from the fluid reservoir 102. The fluid reservoir 102 is located in the interior of the control box 404. The fluid reservoir 102 is connected to the pump 412 by a hose (not shown) or the pump 412 is permanently affixed to a predetermined exterior position on the fluid reservoir 102 so as to eliminate the need for a connecting hose (not shown).

When a smoke detector senses smoke, the smoke detector sends a signal either via the electrical wire or via a wireless means (not shown) to the CPU 408. The CPU 408 then processes said signal, and transfers electrical power to the pump 412. Located on the pump 412 is a high-pressure outlet (not shown), which is connected to the dispensing element 104. The dispensing element 104 has a length that enables it to run up the height of the Christmas tree 108. The dispensing element 104 also has a plurality of holes 110 that are cut out of the fire extinguishing tube 104 so that when fire-retardant fluid (not shown) travels up the fire extinguishing tube 104, a stream of fire-retardant fluid is ejected from the tube 104. The result is a plurality of streams of fire-retardant fluid (not shown) that encompasses every possible area that a fire might burn from the Christmas tree 108.

When either the smoke detector senses smoke or the heat detector senses heat, the respective detector will send a signal to the CPU 408, which will in turn transmit an audible signal to a speaker 414. The speaker 414 will generate noise that is comparable to any smoke detector or alarm. In the event of a fire in which the fire extinguishing means provided is not effective, an additional feature of the invention is required. The additional feature of the invention is to continuously run the speaker system 414 for an extended period regardless of power or the intense heat generated by the fire, which may destroy the smoke detector. This added feature provides the end user with peace of mind in knowing that the alarm will continue to sound long after various components of the invention are destroyed or from loss of power provided by the power cord or where the fire extinguishing means prove not effective in putting out the fire.

An additional feature of the invention is to provide a remote alarm system 416 that consists of a transmitter 418 that is electrically wired to the CPU 408. The transmitter 418 sends a radio signal out from the invention to a remote receiver, which will activate an alarm system that is broadcasted over a remote speaker. The remote receiver, alarm system, and remote speaker are contained within a housing (not shown) that is separate from the rest of the invention and can be located anywhere within a predetermined range of the transmitter 418. The benefit of the remote alarm system 416 is to provide a more expansive alarm system 416 that can be heard at a greater distance, which may be required for a large home, a home with a guest house, or similar residential accommodations.

In one embodiment, the fire safety device 100 further may include a mechanism for automatically emitting an alarm signal when the automatic fire-retardant agent is discharged. The combined elements of the automatic alarm signal emitting mechanism and the automatic fire-retardant agent provide an unexpected benefit wherein the device 100 not only prevents fires from spreading and extinguishes fires, but also warns users of the dangerous conditions.

Upon activation, the automatic alarm signal emitting mechanism 420 may be independently and simultaneously operable from the reservoir 102. This operates such that the alarm signal is continuously emitted after the fire-retardant agent is depleted from the air-pressurized reservoir 102 while the real-time ambient temperature level is above the maximum threshold temperature level. This may notify the user from a distance that a dangerous condition may still be present even after the device 100 has discharged all fire-retardant agent.

The automatic alarm signal emitting mechanism 420 may further include a power source (not shown). Such a power source may be a standard alkaline battery coupled to the automatic alarm signal 420, thereby allowing the alarm signal to be activated even if a power outage were present. Also, a temperature-detecting controller may be electrically coupled to the power source and arranged in such a manner to detect the real-time ambient temperature level surrounding the existing Christmas tree 108.

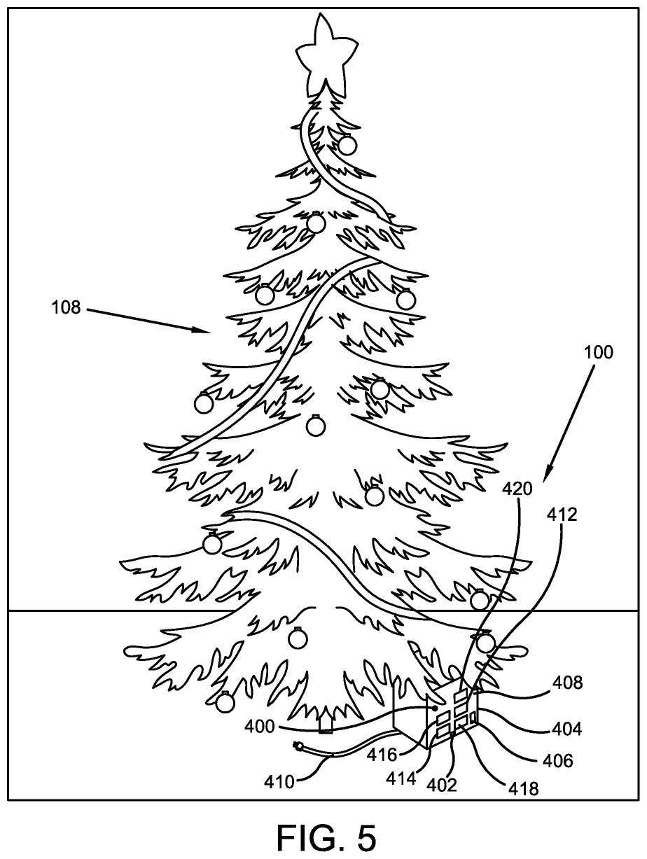

As shown in FIG. 5, should a Christmas tree 108 catch fire, such as from defective wiring from Christmas lights, the fire will generate heat and smoke. In response to sensing heat and/or smoke from the fire, sensors 302 are responsive and generate signals to valve 116 causing it to move from its normal closed position to an open position. When valve 116 moves into its open position, the fire-retardant material maintained by reservoir 102 passes forcibly from reservoir 102 to the tube 104 through the conduit assembly 202 and is dispersed forcibly from the foramina 110 formed in the tube 104 along the entire length of the tube 104 from the proximal end 204 at the lower end of the branched structure to the distal end 206 at the upper end of the branched structure. In this manner, the fire retardant is dispersed outwardly from the elongate, foraminous tube 104 onto the trunk 106 and into and through the branched structure from the lower end to the upper end to provide fire suppression in and throughout the branched structure or Christmas tree 108.

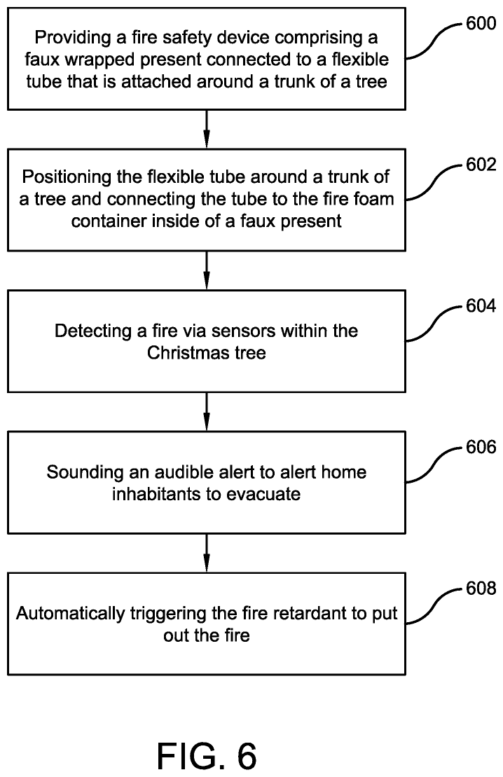

FIG. 6 illustrates a flowchart of the method of maintaining household safety while having a fully lit and decorated Christmas tree for the holidays. The method includes the steps of at 600, providing a fire safety device comprising a faux wrapped present connected to a flexible tube that is attached around the trunk of a Christmas tree, the device releases fire retardant onto the tree when on fire. The method also comprises at 602, positioning the flexible tube around a trunk of a Christmas tree and connecting the tube to the fire foam container inside of a faux present. Further, the method comprises at 604, detecting a fire via sensors within the Christmas tree. The method comprises at 606, sounding an audible alert to alert home inhabitants to evacuate. Finally, at 608, automatically triggering the fire retardant to put out the fire.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “fire safety device” and “device” are interchangeable and refer to the fire safety device 100 of the present invention.

Notwithstanding the foregoing, the fire safety device 100 of the present invention can be of any suitable size and configuration as is known in the art without affecting the overall concept of the invention, provided that it accomplishes the above-stated objectives. One of ordinary skill in the art will appreciate that the fire safety device 100 as shown in FIGS. 1-6 are for illustrative purposes only, and that many other sizes and shapes of the fire safety device 100 are well within the scope of the present disclosure. Although the dimensions of the fire safety device 100 are important design parameters for user convenience, the fire safety device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fire safety device for maintaining household safety during a holiday season, the fire safety device comprising:
a reservoir comprising a fire-retardant material;
a dispensing element that is attached around a trunk of a tree and is in fluid communication with the reservoir; and
a detection assembly in communication with the dispensing element, wherein, upon a detection of a smoke or fire by the detection assembly, the dispensing element dispenses the fire-retardant material onto the tree.

2. The fire safety device of claim 1, wherein the reservoir is a faux wrapped present.

3. The fire safety device of claim 2, wherein the dispensing element is a flexible tube.

4. The fire safety device of claim 3, wherein the flexible tube comprises a plurality of openings or nozzle heads.

5. The fire safety device of claim 4, wherein the detection assembly comprises a plurality of sensors capable of detecting the smoke or fire or an elevated temperature.

6. The fire safety device of claim 5, wherein the dispensing element comprises a valve for releasing the fire-retardant material.

7. The fire safety device of claim 6, wherein the reservoir comprises a manual shut off valve.

8. The fire safety device of claim 7, wherein the reservoir comprises a conduit assembly coupled to the dispensing element.

9. The fire safety device of claim 8, wherein the dispensing element comprises a proximal end coupled to the conduit assembly and a distal end attached to the detection assembly.

10. The fire safety device of claim 9, wherein the detection assembly comprises a housing having a plurality of sensors and a power source.

11. The fire safety device of claim 10, wherein the housing is in communication with the valve to facilitate a signal communication between the plurality of sensors and the valve.

12. The fire safety device of claim 11, wherein a response from at least one of the plurality of sensors sends a signal to the valve that causes the valve to reposition from a closed position to an open position.

13. The fire safety device of claim 12, wherein the detection assembly comprises an audible alarm for alerting an occupant of a fire threat.

14. The fire safety device of claim 13 further comprising a control box located within the reservoir.

15. A fire safety device for maintaining household safety during a holiday season, the fire safety device comprising:
a reservoir and a control box comprising a fire-retardant material that is shaped as a faux wrapped present;
a dispensing element that is attached around a trunk of a tree and in communication with the reservoir; and
a detection assembly in communication with the dispensing element;
wherein the dispensing element comprises a flexible tube with a plurality of openings or nozzle heads and a valve for releasing the fire-retardant material;
wherein the detection assembly comprises a plurality of sensors;
wherein a response from at least one of the plurality of sensors sends a signal to the valve causing the valve to reposition from a closed position to an open position;
wherein once a smoke or fire is detected by the detection assembly, the dispensing element dispenses the fire-retardant material onto the tree; and
wherein the control box is in communication with each of the reservoir, the dispensing element, and the detection assembly.

16. The fire safety device of claim 15, wherein the control box comprises an on/off switch in communication with a central processing unit (CPU) and a pump for pumping the fire-retardant material.

17. The fire safety device of claim 16, wherein a power cord connects to the CPU to provide power thereto.

18. The fire safety device of claim 17 further comprising a remote alarm system in communication with the CPU.

19. The fire safety device of claim 17 further comprising an automatic alarm in communication with the CPU.

20. A method of maintaining household safety while having a fully lit and decorated Christmas tree, the method comprising the steps of:
providing a fire safety device comprising a faux wrapped present connected to a flexible tube that is attached around a trunk of the Christmas tree, and that releases a fire-retardant material onto the Christmas tree when on fire;
positioning the flexible tube around the trunk of the Christmas tree, and connecting the flexible tube to a fire foam container inside of a faux wrapped present;
detecting a fire via a plurality of sensors on the Christmas tree;
sounding an audible alert to alert an occupant of the fire; and
automatically dispensing the fire-retardant material to put out the fire.
